(19) United States
(12) Patent Application Publication
(10) Pub. No.: US 2009/0237182 A1
(43) Pub. Date: Sep. 24, 2009

(54) Compact single-to-balanced bandpass filter

(75) Inventors: Shyh-Jong Chung, Hsinchu County (TW); Kun-Tzu Chen, Taoyuan County (TW)

Correspondence Address: BACON & THOMAS, PLLC, 625 SLATERS LANE, FOURTH FLOOR, ALEXANDRIA, VA, 22314-1176, US

(73) Assignee: National Chiao Tung University, Hsinchu City (TW)

(21) Appl. No.: 12/153,205

(22) Filed: May 15, 2008

(30) Foreign Application Priority Data
Mar. 21, 2008 (TW) 097110138

(51) Int. Cl. H01P 1/203; H01P 5/10

(52) U.S. Cl. 333/204; 333/26

(57) ABSTRACT

A compact single-to-balanced bandpass filter is proposed in this invention. Firstly, a pre-design circuit is presented, which is composed of an inductive coupled-line (ICL) bandpass filter and an out-of-phase capacitive coupled-line (CCL) bandpass filter. A novel compact circuit with three coupled lines configuration, derived from the pre-design circuit, is then proposed for miniaturizing the single-to-balanced bandpass filter. In order to verify the feasibility of the proposed structure, a 2.4 GHz multilayer ceramic chip type single-to-balanced bandpass filter with size of 2.0 mm×1.2 mm×0.7 mm is developed. The filter is designed by using circuit simulation as well as full-wave electromagnetic (EM) simulation softwares, and fabricated by the use of low-temperature co-fire ceramic (LTCC) technology. The measured results agree quite well with the simulated. According to the measurement results, the maximum insertion loss is 1.65 dB, the maximum in-band phase imbalance is within 3 degrees, and the maximum in-band magnitude imbalance is less than 0.32 dB.

### BACKGROUND OF THE INVENTION

1. Field of the Invention

The present invention relates to bandpass filters, and more particularly, to a compact single-to-balanced bandpass filter.

2. Description of Related Art

Taiwanese Patent No. M292793 (hereinafter referred to as citation 1), entitled Compact Multilayer Single-to-balanced Bandpass Filter, proposes a compact multilayer single-to-balanced bandpass filter which comprises a plurality of substrates formed with at least one coupled line thereon, wherein the coupled lines are coupled and aligned in pairs, while a first one and a last one of the coupled lines are equipped with one unbalanced input end and two balanced output ends respectively for reducing signal attenuation and coupling interference. Taiwanese Patent No. M292793 discloses a structure in which three coupled lines are coupled to one another in pairs so as to form a bandpass filter, wherein the first one and the last one of the coupled lines are equipped with one unbalanced input end and two balanced output ends respectively, as shown in FIG. 1. Basically, citation 1 is realized by a combination of a balun and a bandpass filter that is configured to receive unbalanced input signals and output balanced signals. However, effective reduction of dimensions is unlikely to be accomplished by Taiwanese Patent No. M292793 as the structure disclosed therein requires coupled lines having lengths equal to half a wavelength of the operating frequency.

“A Balance Filter with DC Supply for Bluetooth Module” (hereinafter referred to as citation 2) by Dae-Woun YOO, Eung-Soo KIM and Sung-Wook KIM, presented in 2005 European Microwave Conference, teaches fabricating a conventional balun and a filter concurrently on a same LTCC substrate so as to form a new component. However, no indispensable elements are spared (still using a balun and a bandpass filter), so that the dimensions, 6.35×6.35 mm², of the component thus formed remain unabated.

“A laminated balance filter using LTCC technology” (hereinafter referred to as citation 3) by Min Cheol Park, Byoung Hwa Lee and Dong Seok Park, in Microwave Conference Proceedings, 2005. APMC 2005. Asia-Pacific Conference Proceedings, discloses, among others, a set of coupled lines to be commonly used by a balun and a filter. Nevertheless, lengths of the coupled lines have to equal lengths of coupled lines of a conventional balun (a quarter of the wavelength of the center frequency), thereby allowing little downsizing.

### SUMMARY OF THE INVENTION

To overcome the drawbacks of the prior art, it is a primary objective of the present invention to provide a compact single-to-balanced bandpass filter, wherein a circuit structure of the compact single-to-balanced bandpass filter is simplified, so as to reduce dimensions of related components effectively and improve frequency response of the compact single-to-balanced bandpass filter. The present invention provides two bandpass filters coupled in different directions as major components of the compact single-to-balanced bandpass filter and simplifies the two bandpass filters with a view to achieving miniaturization. The compact single-to-balanced bandpass filter is provided with three resonator, namely a first resonator, a second resonator, and a third resonator, wherein the first and the second resonators form an inductive coupled-line (ICL) filter while the first and the third resonators form a capacitive coupled-line (CCL) filter, in which three coupled lines are used to implement an inductively coupled line (ICL) and a capacitively coupled line (CCL). The compact single-to-balanced bandpass filter further comprises one input end P1 and two output ends P2 and P3. An unbalanced signal inputted to the input end P1 is coupled, from the first resonator to the second and third resonators, with a same coupling energy, allowing the two output ends P2 and P3 to output signals of a same magnitude (i.e., half of a magnitude of an input energy).

Comparatively speaking, commercially available 2.4 GHz bandpass filters have dimensions of 2.0×1.2 mm or 2.5×2.0 mm and an insertion loss of approximately 2.2 dB, whereas a balun has dimensions of 1.6×0.8 mm or 2.0×1.2 mm and an insertion loss of approximately 1 dB. On the other hand, the compact single-to-balanced bandpass filter according to the present invention has dimensions of 2.0×1.2 mm and an insertion loss of 1.65 dB, wherein a balun and a bandpass filter are integrated into a single component in the present invention, thereby achieving component miniaturization as well as improving frequency response of the components. Compared with citation 1, the coupled lines provided by the present invention have lengths far shorter than a quarter of a wavelength of an operating frequency, thereby enabling effective reduction of component dimensions during a fabrication process. Compared with citations 2 and 3, the present invention integrates a balun and a bandpass filter into a single component, whose dimensions are reduced to 2.0×1.2 mm in an embodiment of the present invention. The compact single-to-balanced bandpass filter of the present invention is applicable to any systems that comprise a balun and a bandpass filter, such as a wireless LAN (local area network) system and a Bluetooth system.

### BRIEF DESCRIPTION OF THE DRAWINGS

FIG. 1 is a schematic view of a conventional embodiment of a balun and a bandpass filter;

FIG. 2(a) is a schematic view showing a circuit structure of a compact single-to-balanced bandpass filter according to the present invention;

FIG. 2(b) is a schematic view showing a simplified circuit of the compact single-to-balanced bandpass filter based on the circuit structure shown in FIG. 2(a);

FIG. 3 is a graph of simulated results, produced by circuit simulation software, based on the circuit structure of the compact single-to-balanced bandpass filter according to the present invention;

FIG. 4(a) is a graph of actual simulated results and measured results of the present invention;

FIG. 4(b) is a graph of magnitude imbalance and phase imbalance actually measured of the present invention;

FIG. 4(c) is a graph depicting transmission characteristics of balanced signals and unbalanced signals of the present invention;

FIG. 5(a) is a schematic view showing a structure of an inductive coupled-line (ICL) bandpass filter;

FIG. 5(b) is a schematic view showing a structure of a capacitive coupled-line (CCL) bandpass filter; and

FIG. 5(c) is a graph of a parameter ∠Z21 of the inductive coupled-line (ICL) bandpass filter and the capacitive coupled-line (CCL) bandpass filter.

### DETAILED DESCRIPTION OF THE PREFERRED EMBODIMENT

The following preferred embodiment is provided to illustrate the present invention. Others skilled in the art can easily understand other advantages and features of the present invention in accordance with the specification and the accompanying drawings.

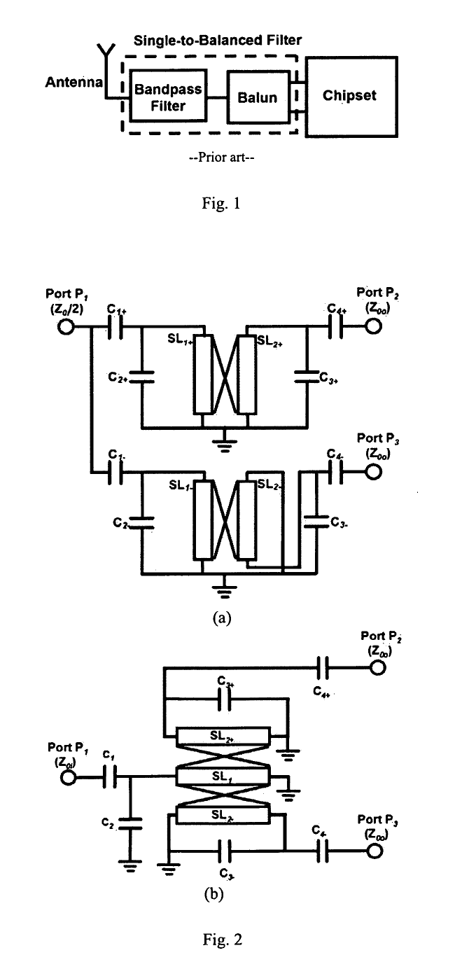

Referring to FIG. 1, which is a schematic view of a conventional embodiment of a balun and a bandpass filter, the balun and bandpass filter (enclosed by the dashed line) in the drawing define the part of the prior art that is intended to be replaced by a compact single-to-balanced bandpass filter according to the present invention, in the hope of downsizing related components and improving performance thereof.

FIGS. 2(a) and 2(b) are schematic views showing a circuit structure and a simplified circuit of a compact single-to-balanced bandpass filter according to the present invention, respectively, wherein FIG. 2(a) depicts the circuit structure of the compact single-to-balanced bandpass filter of the present invention while FIG. 2(b) depicts a simplified circuit of the compact single-to-balanced bandpass filter based on the circuit structure shown in FIG. 2(a). Referring to FIG. 2(a), the compact single-to-balanced bandpass filter comprises a complete, inductive coupled-line (ICL) bandpass filter and a complete, capacitive coupled-line (CCL) bandpass filter, wherein a total of four inductors and eight capacitors are provided. More particularly, the two bandpass filters coupled in different directions are composed of an inductive coupled-line (ICL) bandpass filter and an out-of-phase capacitive coupled-line (CCL) bandpass filter connected in parallel. Referring to FIG. 2(b), an inductively coupled line (ICL) and a capacitively coupled line (CCL) are implemented by three coupled lines, wherein capacitor C₁, capacitor C₄₊ and capacitor C₄₊ function as DC block capacitors configured for matching and adjustment. The compact single-to-balanced bandpass filter of the present invention is provided with three resonators, namely a first resonator formed by a capacitor C₂ and a line SL₁, a second resonator formed by a capacitor C₃₊ and a line SL₂₊, and a third resonator formed by a capacitor C₃ and a line SL₂.

As shown in FIG. 2(a), the inductive coupled-line (ICL) bandpass filter and the capacitive coupled-line (CCL) bandpass filter form a single-to-balanced bandpass filter. Referring to FIG. 2(b), the inductively coupled line (ICL) and the capacitively coupled line (CCL) are implemented by three coupled lines, so as to realize the single-to-balanced bandpass filter. Referring to FIG. 2(b) again, an unbalanced signal inputted to an input end Port P1 is coupled, from the first resonator to the second and third resonators, with a same coupling energy, so that two output ends Port P2 and Port P3 output signals of a same magnitude (i.e., half of a magnitude of an input energy). Furthermore, an inductive coupled-line (ICL) filter is formed by the first resonator and the second resonator, while a capacitive coupled-line (CCL) filter is formed by the first resonator and the third resonator, wherein a phase imbalance between signals outputted from the output end Port P2 and the output end Port P3 is 180°. Given the aforesaid conditions, an unbalanced signal inputted to the input end Port P1 which falls within a preset passband can be converted into balanced signals outputted from the output ends Port P2 and Port P3, while signals outside the design passband are filtered out, thereby providing the function of a balun and the function of a bandpass filter simultaneously.

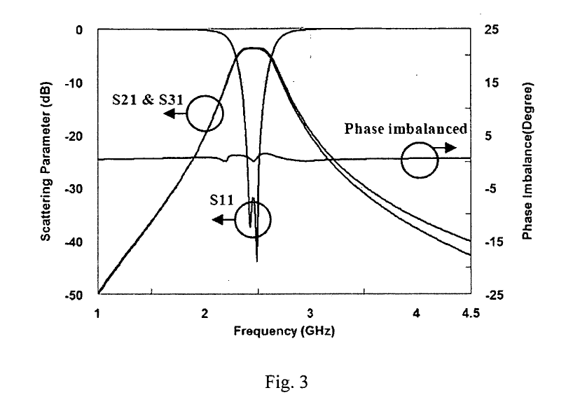

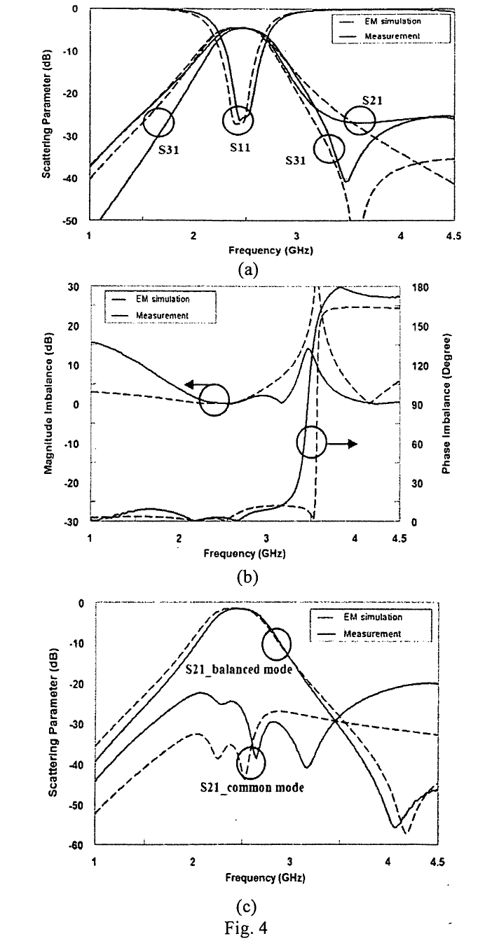

FIG. 3 is a graph of simulated results, produced by circuit simulation software, of the circuit structure of the compact single-to-balanced bandpass filter according to the present invention. As shown in FIG. 3, the circuit exhibits, at S21 and S31, a maximum in-band insertion loss of 3.5 dB, a minimum in-band reflection loss of 34.4 dB, a maximum in-band magnitude imbalance of 0.6 dB, and a maximum in-band phase imbalance of 4°, thus meeting the characteristic requirements for a single-to-balanced bandpass filter. FIGS. 4(a), 4(b) and 4(c) illustrate a comparison between measured results and simulated results of the simplified circuit (of FIG. 2(b)), wherein the actually measured results are indicated by solid lines and the EM (electromagnetic) simulated results are indicated by dashed line. As shown in FIG. 4(a), the measured results agree quite well with the simulated results, wherein the measured results at S11 reveal two in-band poles around 2.44 GHz and a minimum in-band reflection loss of 27 dB; the measured results at S21 and S31 reveal a maximum in-band insertion loss of −4.7 dB; and the measured results at S31 reveal a transmission zero around 3.5 GHz, as predicted by the EM simulated results. Referring to FIG. 4(b), which is a graph of magnitude imbalance and phase imbalance actually measured from the single-to-balanced bandpass filter, two balanced input (output) ports are out-of-phase before the transmission zero appears (around 3.5 GHz) at S31 but become in-phase after the transmission zero appears, with an in-band magnitude imbalance smaller than 0.32 dB and an in-band phase imbalance smaller than 3°. As demonstrated by the aforesaid results, the single-to-balanced bandpass filter exhibits excellent in-band balance. FIG. 4(c) is a graph depicting transmission characteristics of balanced signals and unbalanced signals of the single-to-balanced bandpass filter. The measured results of balanced signals reveal that the single-to-balanced bandpass filter has a maximum in-band insertion loss of 1.65 dB, while the measured results of unbalanced signals reveal a minimum in-band insertion loss of −24 dB. In addition, the measured results of balanced signals reveal a transmission zero around 4.2 GHz, and a similar result is also found from the EM simulations. This transmission zero appears because an out-of-phase to in-phase transition takes place at S21 and S31 around 3.5 GHz, and magnitudes become equal at S21 and S31 at 4.2 GHz. As a result, signals are offset by one another at a balanced port, and the transmission zero therefore appears around 4.2 GHz. The transmission zero inhibits harmonic signals generated at 4.2 GHz by a 2.1 GHz local oscillator, so that noise attenuates by at least 50 dB at that frequency point.

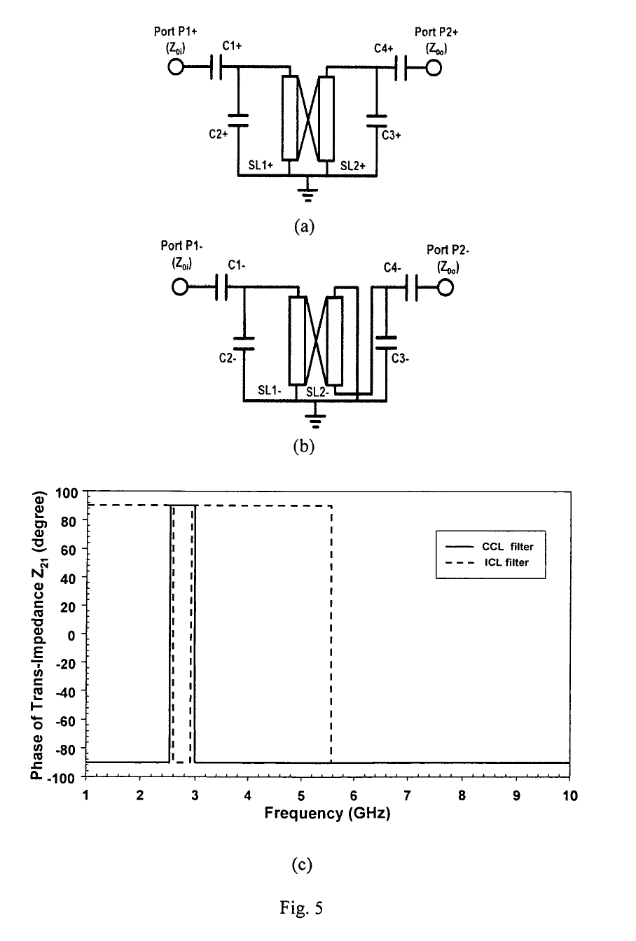

FIGS. 5(a), 5(b) and 5(c) provide additional information, wherein FIG. 5(a) is a schematic view showing a structure of an inductive coupled-line (ICL) bandpass filter, FIG. 5(b) is a schematic view showing a structure of a capacitive coupled-line (CCL) bandpass filter, and FIG. 5(c) is a graph of a parameter ∠Z₂₁ of the inductive coupled-line (ICL) bandpass filter and the capacitive coupled-line (CCL) bandpass filter. As shown in the figures, the inductive coupled-line (ICL) bandpass filter has an in-band parameter ∠Z₂₁ of −90°, while the capacitive coupled-line (ICL) bandpass filter has in-band ∠Z₂₁ parameter of +90°.

The compact single-to-balanced bandpass filter of the present invention is applicable to any systems that comprise a balun and a bandpass filter, such as a wireless LAN (local area network) system and a Bluetooth system.

What is claimed is:

1. A compact single-to-balanced bandpass filter, comprising an inductive coupled-line (ICL) bandpass filter and a capacitive coupled-line (CCL) bandpass filter, characterized in that the compact single-to-balanced bandpass filter is provided with three resonators, namely a first resonator, a second resonator, and a third resonator, wherein the first resonator and the second resonator form an inductive coupled-line (ICL) filter while the first resonator and the third resonator form a capacitive coupled-line (CCL) filter.

2. The compact single-to-balanced bandpass filter of claim 1, wherein an inductively coupled line (ICL) and a capacitively coupled line (CCL) are implemented by three coupled lines.

3. The compact single-to-balanced bandpass filter of claim 1, further comprising an input end, a first output end and a second output end, such that an unbalanced signal inputted to the input end is coupled, from the first resonator to the second and the third resonators, with a same coupling energy, so that the first output end and the second output end output signals having a same magnitude (i.e., half of a magnitude of an input energy).

4. The compact single-to-balanced bandpass filter of claim 3, wherein a phase imbalance between the signals outputted from the first and the second output ends is 180°.

5. The compact single-to-balanced bandpass filter of claim 3, wherein the unbalanced signal inputted to the input end is converted into the balanced signals outputted from the first and the second output ends if the unbalanced signal falls within a preset passband, and signals outside the preset passband are filtered out.

6. The compact single-to-balanced bandpass filter of claim 1, further comprising a DC block capacitor for providing matching and adjustment.

7. The compact single-to-balanced bandpass filter of claim 1, wherein the first resonator is formed by a capacitor C₂ and a line SL₁, the second resonator is formed by a capacitor C₃₊ and a line SL₂₊, and the third resonator is formed by a capacitor C₃₋ and a line SL₂₋.

8. The compact single-to-balanced bandpass filter of claim 1, wherein the compact single-to-balanced bandpass filter has dimensions of approximately 2.0×1.2 mm.

9. The compact single-to-balanced bandpass filter of claim 1, wherein the compact single-to-balanced bandpass filter has an insertion loss of approximately 1.65 dB.

10. A single-to-balanced bandpass filter, characterized in that two bandpass filters coupled in different directions are used as major components forming the single-to-balanced bandpass filter.

11. The single-to-balanced bandpass filter of claim 10, wherein the filter comprises a complete, inductive coupled-line (ICL) bandpass filter and a complete, capacitive coupled-line (CCL) bandpass filter, in which at least four inductors and eight capacitors are provided.

12. The compact single-to-balanced bandpass filter of claim 2, wherein lengths of the coupled lines are shorter than a quarter of a wavelength of an operating, frequency.

13. The single-to-balanced bandpass filter of claim 10, wherein the two bandpass filters coupled in different directions are composed of an inductive coupled-line (ICL) bandpass filter and an out-of-phase capacitive coupled-line (CCL) bandpass filter connected in parallel.
